(19) United States
(12) Patent Application Publication
(10) Pub. No.: US 2010/0078853 A1
(43) Pub. Date: Apr. 1, 2010

(54) METHOD OF MANUFACTURING STUDLESS TIRE

(76) Inventor: Ryoji KOJIMA, Kobe-shi (JP)

Correspondence Address: BIRCH STEWART KOLASCH & BIRCH, PO BOX 747, FALLS CHURCH, VA, 22040-0747, US

(21) Appl. No.: 12/555,211

(22) Filed: Sep. 8, 2009

(30) Foreign Application Priority Data
Sep. 26, 2008 (JP) 2008-247780

(51) Int. Cl. B29C 71/02

(52) U.S. Cl. 264/236

(57) ABSTRACT

The method of manufacturing a studless tire according to the present invention includes a first step, a second step and a third step. In the first step, a kneaded substance is obtained by kneading a composite rubber component containing mineral oil-extended butadiene rubber and a compounding ingredient excluding sulfur and a vulcanization accelerator. In the second step, an unvulcanized rubber composition is obtained by kneading the kneaded substance while adding sulfur and a vulcanization accelerator thereto. In the third step, the unvulcanized rubber composition is vulcanized in a mold for a tire tread under pressurization and/or heating.

This nonprovisional application is based on Japanese Patent Application No. 2008-247780 filed on Sep. 26, 2008 with the Japan Patent Office, the entire contents of which are hereby incorporated by reference.

### BACKGROUND OF THE INVENTION

1. Field of the Invention

The present invention relates to a method of manufacturing a studless tire.

2. Description of the Background Art

While a studded tire or a snow chain has been employed for driving on an icy road, a studless tire has been substitutionally developed as a tire for driving on an icy road, in order to prevent an environmental problem such as pollution resulting from dust. The material for and the design of the studless tire are so selected that the same is suitable for driving on an icy road remarkably irregular as compared with an ordinary road.

Japanese Patent Laying-Open No. 09-087427 (1997) discloses a rubber composition for a studless tire containing at least one rubber component selected from a group consisting of natural rubber, isoprene rubber and butadiene rubber, silica, a sililation reagent, carbon black and mineral oil in order to improve a gripping property on an icy road.

Japanese Patent Laying-Open No. 2001-288296 discloses a tread rubber composition for a tire containing at least one of natural rubber, synthetic polyisoprene rubber and polybutadiene rubber, sulfur and an organic peroxide in order to provide excellent wear resistance and thermal stability and suppress reduction in gripping property in driving on icy and snowy roads.

In both cases, however, further improvement in ice performance is required.

### SUMMARY OF THE INVENTION

An object of the present invention is to provide a method of manufacturing a studless tire having excellent wear resistance while setting rubber hardness under a low temperature to a low level in order to improve ice/snow performance.

The method of manufacturing a studless tire according to the present invention includes a first step, a second step and a third step. In the first step, a kneaded substance is obtained by kneading a composite rubber component containing mineral oil-extended butadiene rubber and a compounding ingredient excluding sulfur and a vulcanization accelerator. In the second step, an unvulcanized rubber composition is obtained by kneading the kneaded substance while adding sulfur and a vulcanization accelerator thereto. In the third step, the unvulcanized rubber composition is vulcanized in a mold for a tire tread under pressurization/heating.

In the method of manufacturing a studless tire according to the present invention, a rubber component in the composite rubber component preferably contains 20 to 80 mass % of mineral oil-extended butadiene rubber as a rubber content.

In the method of manufacturing a studless tire according to the present invention, the first step preferably includes a step of kneading the obtained kneaded substance while adding oil thereto.

In the method of manufacturing a studless tire according to the present invention, the content of oil added in the first step is preferably 5 to 10 parts by mass with respect to 100 parts by mass of the rubber component in the composite rubber component.

A studless tire obtained by the method of manufacturing a studless tire according to the present invention can compatibly attain excellent ice performance and excellent wear resistance.

The foregoing and other objects, features, aspects and advantages of the present invention will become more apparent from the following detailed description of the present invention.

### DESCRIPTION OF THE PREFERRED EMBODIMENTS

<Compounding Ingredient for Studless Tire>

(Composite Rubber Component)

In the method of manufacturing a studless tire according to the present invention, a composite rubber component containing mineral oil-extended butadiene rubber (hereinafter referred to also as “mineral oil-extended BR”) is used as a compounding ingredient. This is because dispersibility of a reinforcing agent such as carbon black is deteriorated and wear resistance is reduced due to influence of oil subsequently added as a softening agent if non-oil-extended rubber is employed.

According to the present invention, mineral oil is employed as extender oil extending butadiene rubber. This is because aromatic mineral oil or naphthenic mineral oil has such high kinetic viscosity that temperature dependency of rubber hardness is increased and it is difficult to guarantee sufficient maneuverability of the tire.

While a method of extending butadiene rubber with mineral oil is not particularly restricted, mineral oil-extended butadiene rubber can be obtained by adding and mixing mineral oil to and into a polymerized solution or a latex of butadiene rubber and thereafter obtaining a clam by adding a solidifier or the like or directly desolvating the same. Alternatively, mineral oil-extended BR can be prepared by blending butadiene rubber and mineral oil with each other in melted states.

The quantity of mineral oil for extending butadiene rubber is preferably 1 0 to 60 parts by mass with respect to 100 parts by mass of butadiene rubber. If the quantity of mineral oil is less than 100 parts by mass, the quantity of oil thereafter added as a softening agent for reducing temperature dependency is increased and wear resistance is hard to ensure.

Diene rubber is employed for the composite rubber component of the studless tire manufactured according to the present invention in addition to the aforementioned mineral oil-extended BR, in order to obtain excellent properties such as rubber strength and an elastic coefficient. Natural rubber (NR), styrene-butadiene rubber (SBR), isoprene rubber (IR) and isobutylene-isoprene rubber (IIR) can be listed as examples of such diene rubber. One of these materials may be singly employed, or at least two such materials may be combined with each other.

As to the mixing ratio between mineral oil-extended BR and diene rubber, a rubber component in the composite rubber component preferably contains 20 to 80 mass % of mineral oil-extended BR as a rubber content. In other words, mineral oil-extended BR and diene rubber are preferably so blended that the mass of only the rubber content excluding mineral oil is 20 to 80 parts by mass assuming that the sum of the mass of only the rubber content excluding mineral oil and the mass of diene rubber is 100 parts by mass in mineral oil-extended BR, for example. If the mass of only the rubber content is less than 20%, it is difficult to sufficiently attain the effects of reducing the temperature dependency of the rubber hardness and ensuring the wear resistance according to the present invention. If the mass of only the rubber content exceeds 80 mass %, on the other hand, the wear resistance is deteriorated although ice performance is improved. More preferably, the rubber component in the composite rubber component contains 30 to 70 mass % of mineral oil-extended BR as the rubber content.

(Oil)

In the method of manufacturing a studless tire according to the present invention, oil can be singly blended as a softening agent, in addition to mineral oil employed as the extender oil. Mineral oil or aromatic oil can be used as oil. The content of oil is preferably 0 to 40 parts by mass with respect to 100 parts by mass of the rubber component, in view of the wear resistance.

The aforementioned oil can be introduced into the composite rubber component in the initial stage simultaneously with another compounding ingredient. Alternatively, only oil can be additionally introduced and kneaded after a kneaded substance of the composite rubber component and another compounding ingredient is temporarily obtained. When oil is introduced into the composite rubber component in the initial stage simultaneously with another compounding ingredient, the content of oil introduced in the initial stage is preferably not more than 20 parts by mass with respect to 100 parts by mass of the rubber component in the composite rubber component, in order not to inhibit dispersibility of a filler such as carbon black or silica.

(Another Compounding Ingredient)

In the method of manufacturing a studless tire according to the present invention, a reinforcing agent or a filler such as carbon black or silica, a silane coupling agent bonding silica and the rubber component to each other and various additives such as a vulcanizing agent, a vulcanization accelerator, a vulcanization assistant, an antioxidant, a softening agent and a plasticizer can be used if necessary. 5 to 100 parts by mass of carbon black is preferably blended with respect to 100 parts by mass of the rubber component in the composite rubber component. Silica is preferably blended in order to enable compatibleness between rolling resistance and frictional performance on a wet road, and the content thereof is preferably 5 to 100 parts by mass with respect to 100 parts by mass of the rubber component in the composite rubber component.

<Method of Manufacturing Studless Tire>

The method of manufacturing a studless tire according to the present invention includes a first step of obtaining a kneaded substance by kneading a composite rubber component containing mineral oil-extended butadiene rubber and a compounding ingredient excluding sulfur and a vulcanization accelerator, a second step of obtaining an unvulcanized rubber composition by kneading the kneaded substance while adding sulfur and a vulcanization accelerator thereto and a third step of vulcanizing the unvulcanized rubber composition in a mold for a tire under pressurization/heating.

(First Step)

In the first step, the kneaded substance is obtained by kneading a composite rubber component containing mineral oil-extended butadiene rubber and a compounding ingredient excluding sulfur and a vulcanization accelerator. At this time, oil can be singly blended as a softening agent, in addition to mineral oil employed as extender oil. This oil can be introduced into the composite rubber component in the initial stage simultaneously with another compounding ingredient. Alternatively, only oil can be additionally introduced and kneaded after a kneaded substance of the composite rubber component and another compounding ingredient is temporarily obtained. When oil and a filler such a carbon black or silica are separately introduced, dispersibility of the filler as well as wear resistance of tread rubber can be further improved. Therefore, oil is preferably additionally introduced after the kneaded substance is temporarily obtained.

A kneading method is not particularly restricted, but a well-known method such as a method of kneading the materials in a Bambury mixer or the like at a temperature of 100 to 160° C. for one to 10 minutes can be employed. Also in the case of additionally introducing only oil, a well-known method such as the method of kneading the materials in a Bambury mixer or the like at a temperature of 100 to 160° C. for one to 10 minutes can be employed.

(Second Step)

In the second step, an unvulcanized rubber composition is obtained by kneading the kneaded substance obtained in the first step while adding sulfur and a vulcanization accelerator thereto. A kneading method is not particularly restricted, but a well-known method such as a method of kneading the materials in an open roll mill or the like at a temperature of 60 to 100° C. for one to five minutes can be employed.

(Third Step)

The method of manufacturing a studless tire according to the present invention is not particularly restricted, but a generally employed method such as a method of obtaining a tire by extruding the unvulcanized rubber composition in response to the shape of a tire tread and pressurizing/heating the same with a tire molding machine can be employed, for example.

### Examples

The present invention is now more specifically described with reference to Examples and comparative examples.

### Examples 1 to 5 and Comparative Examples 1 to 3>

(Preparation of Unvulcanized Rubber Composition and Studless Tire)

Chemicals having contents shown in “Introduction 1” in Table 1 were introduced into a Bambury mixer and kneaded at a temperature of about 150° C. for five minutes. In each of Examples 2 and 3 and comparative examples 2 and 3, mineral oil having a content shown in “Introduction 2” in Table 1 was further added, and the materials were kneaded at a temperature of about 150° C. for five minutes. Thereafter sulfur and a vulcanization accelerator having contents shown in “Second Step” in Table 1 were added to a kneaded substance obtained in “First Step” shown in Table 1, and the kneaded substance was kneaded in an open roll mill at a temperature of about 80° C. for three minutes, to obtain an unvulcanized rubber composition. The unvulcanized rubber composition was shaped into a tread, bonded to other tire members and vulcanized at a temperature of 170° C. for 15 minutes, thereby preparing a studless tire according to each of Examples 1 to 5 and comparative examples 1 to 3. The obtained unvulcanized rubber composition and the studless tire were evaluated as to the following items:

(Slipperiness)

Such a phenomenon that rubber does not grip a rotor in the kneading in the second step is referred to as a “slip”. Rubber milling cannot be performed if the slip takes place. Presence/absence of the slip was evaluated as follows:

A: nonslipping

B: slipping

(Carbon Dispersibility)

The aforementioned unvulcanized rubber composition was vulcanized at a temperature of 170° C. for 12 minutes, and a thin section of the unvulcanized rubber composition was prepared therefrom with a freezing microtome. As to the thin section of the unvulcanized rubber composition, the ratio of undispersed carbon black was calculated by measuring the quantity of undispersed carbon per unit area of rubber according to ASTMD 2663B with an optical microscope. Assuming that a state where carbon is completely dispersed into the rubber component is 100%, the numerical value is reduced as dispersibility is deteriorated.

(Tensile Break Strength)

The aforementioned unvulcanized rubber composition was vulcanized at a temperature of 170° C. for 12 minutes, and a test piece of 2 mm in thickness was cut out of the same. A tensile test was conducted on the test piece with a dumbbell No. 3 according to JIS K 6251 “Vulcanized Rubber and Thermoplastic Rubber—Method of Obtaining Tensile Characteristics) for measuring tensile break strength (TB) of each composition, and an index was obtained from the following equation with reference to comparative example 1 (100). The tensile break strength is improved as the numerical value is increased.

(tensile break strength index)=(tensile break strength of each composition)/(tensile break strength of comparative example 1)×100

(Ice Braking Performance)

DS-2 studless tires of 19/65R15 were mounted on a domestic RF car of 2000 cc, and actual performance was evaluated under the following conditions:

Test place: Nayoro test course in Hokkaido

Air temperature: −1 to −6° C.

As to ice braking performance, a stopping distance up to a stop after putting on an antilock brake at 30 km/h was measured, and an index was obtained from the following equation with reference to comparative example 1(100). The ice braking performance is improved as the numerical value is increased.

(ice braking performance)=(stopping distance of comparative example 1)/(stopping distance of each composition)×100

(Wear Resistance)

As to wear resistance, DS-2 studless tires of 195/65R15 were mounted on a domestic RF car, depths of grooves of tire treads after traveling 8000 km were measured for calculating a traveling distance when the depths of the tire grooves were reduced by 1 mm, and an index was obtained from the following equation with reference to comparative example 1(100). The wear resistance is improved as the numerical value is increased.

(wear resistance)=(traveling distance of each composition)/(traveling distance of comparative example 1)×100

TABLE 1

| | | | | | | | | | Compar- | Compar- | Compar- |
|---|---|---|---|---|---|---|---|---|---|---|---|
| | | | | | Exam- | Exam- | Exam- | Exam- | ative | ative | ative |
| | | | | Example 1 | ple 2 | ple 3 | ple 4 | ple 5 | Example 1 | Example 2 | Example 3 |
| Compounding | First | Introduction 1 | NR | 60 | 60 | 60 | 40 | 80 | 60 | 60 | 60 |
| | Step | | BR | — | — | — | — | — | 40 | 40 | 40 |
| | | | Mineral Oil-Extended | 55 | 55 | 55 | 82.5 | 27.5 | — | — | — |
| | | | BR | | | | | | | | |
| | | | Carbon Black | 30 | 30 | 30 | 30 | 30 | 30 | 30 | 30 |
| | | | Silica | 20 | 20 | 20 | 20 | 20 | 20 | 20 | 20 |
| | | | Silane Coupling Agent | 1.6 | 1.6 | 1.6 | 1.6 | 1.6 | 1.6 | 1.6 | 1.6 |
| | | | Mineral Oil | 10 | 5 | — | 2.5 | 17.5 | 25 | 5 | 20 |
| | | | Stearic Acid | 2 | 2 | 2 | 2 | 2 | 2 | 2 | 2 |
| | | | Zinc Oxide | 3 | 3 | 3 | 3 | 3 | 3 | 3 | 3 |
| | | | Antioxidant | 1.5 | 1.5 | 1.5 | 1.5 | 1.5 | 1.5 | 1.5 | 1.5 |
| | | | Wax | 1 | 1 | 1 | 1 | 1 | 1 | 1 | 1 |
| | | Introduction 2 | Mineral Oil | — | 5 | 10 | — | — | — | 20 | 5 |

| | | | | | | | | | |
|---|---|---|---|---|---|---|---|---|---|
| Second Step | Sulfur | 1.5 | 1.5 | 1.5 | 1.5 | 1.5 | 1.5 | 1.5 | 1.5 |
| | Vulcanization | 1 | 1 | 1 | 1 | 1 | 1 | 1 | 1 |
| | Accelerator | | | | | | | | |

| | | | | | | | | | |
|---|---|---|---|---|---|---|---|---|---|
| Evaluation | Slipperiness | A | A | A | A | A | A | B | A |
| | Carbon Dispersibility | 92 | 95 | 98 | 98 | 88 | 75 | — | 80 |
| | Tensile Break Strength | 110 | 115 | 115 | 111 | 125 | 100 | — | 100 |
| | Ice Braking Performance | 100 | 100 | 100 | 108 | 95 | 100 | — | 100 |
| | Wear Resistance | 105 | 108 | 109 | 108 | 115 | 100 | — | 101 |

NR: RSS#3
BR: BR150B by Ube Industries, Ltd. (Cis 1, 4 bond quantity=97%, ML₁₊₄(100° C.)=35, viscosity of 5% toluene solution at 25° C.=48, Mw/Mn=3.3)
Mineral Oil-Extended BR: BR133P by Ube Industries, Ltd. (Cis 1, 4 bond quantity=98%, ML₁₊₄(100° C.)=35, viscosity of 5% toluene solution at 25° C.=48, Mw/Mn=2.8, 37.5 parts by weight of mineral oil was blended with respect to 100 parts by weight of butadiene rubber)
Carbon Black: Dia Black I by Mitsubishi Chemical Corporation (ISAF carbon, average particle diameter: 23 mm, DBP oil absorption: 114 ml/100 g, nitrogen adsorption specific surface area: 114 m²/g)
Silica: Ultrasil VN3 by Degussa (specific surface area: 175 m²/g)
Silane Coupling Agent: Si-69 by Degussa
Mineral Oil: PS-32 by Idemitsu Kosan Co., Ltd.
Stearic Acid: Kiri by Nippon Oil and Fats Co., Ltd.
Zinc Oxide: two types of zinc oxide by Mitsui Mining and Smelting Co., Ltd.
Antioxidant: Nocrack 6C by Ouchi Shinko Chemical Industrial
Wax: Ozoace Wax by Nippon Seiro Co., Ltd.
Sulfur: powdered sulfur by Tsurumi Chemical Co., Ltd.
Vulcanization Accelerator: Nocceler NS by Ouchi Shinko Chemical Industrial

(Performance Evaluation)

Mineral oil-extended BR was used in each of Examples 1, 4 and 5. Example 1 was equivalent in ice braking performance to comparative example 1, and excellent in tensile break strength and wear resistance. Example 4 had a larger content of mineral oil-extended BR as compared with Example 1, and was excellent in ice braking performance. Example 5 was slightly inferior in ice braking performance to comparative Example 1, and excellent in tensile break strength and wear resistance.

Mineral oil-extended BR was used and mineral oil was introduced separately from a filler in the first step in each of Examples 2 and 3. Each of Examples 2 and 3 was equivalent in ice braking performance to comparative example 1, and excellent in tensile break strength and wear resistance.

No mineral oil-extended BR was used in each of comparative examples 1 to 3. Comparative example 2 caused a slip. Comparative example 3 was equivalent in all evaluation items to comparative example 1.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of manufacturing a studless tire, comprising:
a first step of obtaining a kneaded substance by kneading a composite rubber component containing mineral oil-extended butadiene rubber and a compounding ingredient excluding sulfur and a vulcanization accelerator;
a second step of obtaining an unvulcanized rubber composition by kneading said kneaded substance while adding sulfur and a vulcanization accelerator thereto; and
a third step of vulcanizing said unvulcanized rubber composition in a mold for a tire tread under pressurization and/or heating.

2. The method of manufacturing a studless tire according to claim 1, wherein
a rubber component in said composite rubber component contains 20 to 80 mass % of said mineral oil-extended butadiene rubber as a rubber content.

3. The method of manufacturing a studless tire according to claim 1, wherein
said first step includes a step of kneading obtained said kneaded substance while adding oil thereto.

4. The method of manufacturing a studless tire according to claim 3, wherein
the content of said oil added in said first step is 5 to 10 parts by mass with respect to 100 parts by mass of said rubber component in said composite rubber component.
